(19) United States
(12) Patent Application Publication
(10) Pub. No.: US 2009/0051607 A1
(43) Pub. Date: Feb. 26, 2009

(54) Conductive Textile, Antenna, and Vehicle Seat

(75) Inventors: Stefan Ellinger, Regensburg (DE); Manfred Geyer, Regensburg (DE); Peter Karges, Regensburg (DE); Gerhard Wild, Regensburg (DE); Jurgen Zacherl, Donaustauf (DE)

Correspondence Address: LERNER GREENBERG STEMER LLP, P O BOX 2480, HOLLYWOOD, FL, 33022-2480, US

(73) Assignee: VDO AUTOMOTIVE AG, Regensburg (DE)

(21) Appl. No.: 12/067,814

(22) PCT Filed: Sep. 28, 2006
(86) PCT No.: PCT/EP06/66828

§ 371 Date: Aug. 29, 2008

(30) Foreign Application Priority Data
Sep. 30, 2005 (DE) 10 2005 046 947.7

(51) Int. Cl. H01Q 1/36; H01Q 1/32

(52) U.S. Cl. 343/711; 343/897

(57) ABSTRACT

At least one antenna is disposed and fixed in a vehicle seat. The at least one antenna is formed from a conductive textile or nonwoven formed separately from a seat cover of the vehicle seat. Preferably, the at least one antenna can be coupled to a transmitting or receiving unit.

The invention relates to a conductive textile, an antenna and a vehicle seat with an antenna, in particular an antenna of a child-seat recognition system or a seat occupancy system.

DE 198 21 501 A1 discloses a seat pad cover of a vehicle seat, into which an antenna of a child-seat recognition system is woven. Said antenna interacts with a resonator or transponder attached to the child seat. The antenna is configured as a wire which is woven into the seat pad cover.

EP 0 983 162 B1 discloses a mat with a heatable wire for vehicle seat heating. In addition to the heatable wire, the mat exhibits an antenna for sending or receiving electromagnetic signals. The antenna is intended to interact with a resonator or transponder of a child seat that is positioned on the vehicle seat. The mat is arranged between a seat pad and the seat pad cover of the vehicle seat.

DE 37 41 023 A1 discloses a textile product with electrically conductive interlining. The textile product is in particular a seat cushion or a seat cover. The interlining is formed from electrically conductive material and is arranged in the seat cushion or seat cover in order to prevent electrostatic charging.

WO 01/44546 discloses electrically conductive textile materials that can be used as vehicle upholstery materials, as electrically heatable seat fabric for use in vehicles, as a carrier material, and/or as a component part of a transmitter or receiver, or as an antenna.

The object of the invention is to provide a conductive textile that can be reliably fixed in a seat pad of a vehicle seat. The object of the invention is furthermore to provide an antenna that can be simply and reliably fixed in the seat pad of the vehicle seat. It is furthermore the object of the invention to provide a vehicle seat with at least one antenna that can be simply and cost-effectively manufactured.

The objects are achieved by the features of the independent claims. Advantageous developments of the invention are specified in the sub-claims.

According to a first aspect, the invention is characterized by a conductive material comprising threads or fibers that are formed from a conductive material or coated in a conductive material or interspersed with a conductive material. The conductive material is woven as a wide mesh so that the foam of a seat pad of a vehicle seat can penetrate the conductive textile during the manufacture of the seat pad. This means that the conductive textile can be particularly easily and reliably fixed in the seat pad and can furthermore be electrically insulated.

According to a second aspect, the invention is characterized by an antenna that is formed from the conductive material according to the first aspect and that can be coupled to a transmitting or receiving unit. The advantage is that the antenna made from the conductive material is stretchable, flexible and easy to process. Furthermore, the antenna can be particularly easily and reliably fixed in the seat pad by laying it in foam. A further advantage is that the foam of the seat pad electrically insulates the antenna.

According to a third aspect, the invention is characterized by a vehicle seat in which at least one antenna is arranged and fixed in a seat pad by means of laying it in foam. The at least one antenna is formed from a conductive textile or nonwoven formed separately from a seat cover of the vehicle seat. The at least one antenna can be coupled to a transmitting or receiving unit.

The advantage is that the antenna made from conductive textile or nonwoven is stretchable, flexible and easy to process. Furthermore, the antenna made from conductive textile or nonwoven can be overstitched and is robust. The at least one antenna can thus be arranged and fixed in the vehicle seat very easily without impairing comfort. A further advantage is that the at least one antenna can be manufactured independently of the seat cover and, depending on the relevant requirements, can be arranged at various locations in the vehicle seat, in particular against or in various layers of the vehicle seat, e.g. also in the side bolsters of the vehicle seat. This enables a large detection area of the at least one antenna. Furthermore, the at least one antenna made from conductive textile or nonwoven follows the contours of the vehicle seat. This means that mechanical loads that can occur in an area of the conductive textile or nonwoven, due to the stitching of the seat cover for example, do not result in damage to or loss of function of the at least one antenna due to its high level of robustness, stretchability and flexibility. The vehicle seat can therefore be easily and cost-effectively manufactured. A further advantage is that the foam of the seat pad insulates the at least one antenna.

In an advantageous embodiment of the vehicle seat, the conductive textile is woven as a wide mesh. This ensures a particularly high degree of stretchability and permeability, e.g. for liquids. Furthermore, the foam of the seat pad can penetrate the conductive textile. This fixes the at least one antenna easily and reliably in the seat pad.

In a further advantageous embodiment of the vehicle seat, the at least one antenna is arranged and fixed in or against the seat cover, or in or against a textile, nonwoven or foam layer between the seat cover and the seat pad, or against a seat-heating or seat-occupancy mat. This has the advantage that a separate layer is not required in the vehicle seat for the at least one antenna and that existing layers of the vehicle seat can be used. This means that the vehicle seat can be particularly easily and cost-effectively manufactured.

In a further advantageous embodiment of the vehicle seat, the at least one antenna is fixed by stitching, weaving, bonding or laminating. This has the advantage that the vehicle seat can be easily and cost-effectively manufactured.

Alternatively, the at least one antenna can be fixed in the seat pad by laying it in foam. The advantage is that the foam of the seat pad electrically insulates the at least one antenna. If the conductive textile is woven as a wide mesh, the foam of the seat pad can penetrate the conductive textile. The at least one antenna is thus particularly easily and reliably fixed in the seat pad.

Exemplary embodiments of the invention are described below with reference to the schematic drawings, in which;

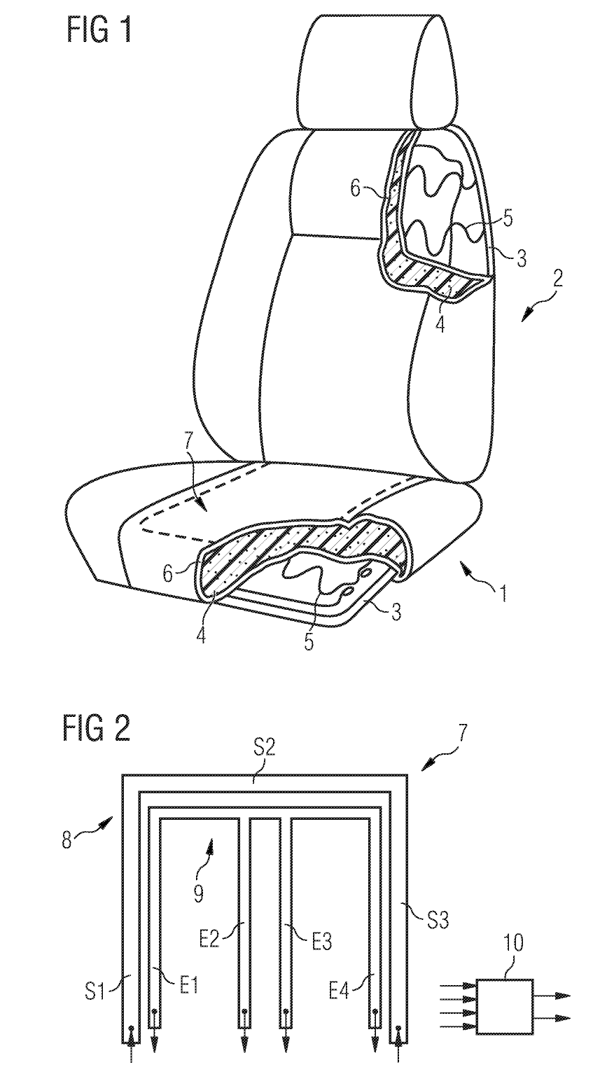

FIG. 1 shows a vehicle seat, and

FIG. 2 shows a transmitting antenna and a receiving antenna, and a transmitting and receiving unit.

Elements with the same construction or function have the same reference numerals in all figures.

A vehicle seat, in particular a front-passenger seat for a vehicle, comprises a seat base 1 and a backrest 2 (FIG. 1). The vehicle seat comprises a seat frame 3 with seat springs 5, on which a seat pad 4 is arranged. The seat pad 4 is covered by a seat cover 6. The seat cover 6 is configured from a single layer or multiple layers. Furthermore, one or more layers may be arranged between the seat pad 4 and the seat cover 6. The seat cover 6 and any layers arranged between the seat pad 4 and the seat cover 6 are preferably formed from a textile, nonwoven or foam material. However, a plastic or leather material for example can also be envisaged. Furthermore, a further layer, comprising a seat-heating or seat-occupancy mat for example, can be arranged between the seat pad 4 and the seat cover 6.

At least one antenna 7, in particular for a child-seat recognition system or a seat-occupancy system, is arranged in the seat base 1. The at least one antenna 7 is configured separately from the seat cover 6 of the vehicle seat and is formed from a conductive textile or nonwoven. In addition to the properties of textile or nonwoven material, the conductive textile or nonwoven exhibits a low ohmic resistance.

The conductive textile or nonwoven comprises threads or fibers that are formed from a conductive material, e.g. copper, or that are coated with a conductive material, e.g. with a copper lacquer, or that are interspersed with a conductive material. The conductive textile or nonwoven can also comprise non-conductive threads or fibers in addition to these types of conductive threads or fibers. Furthermore, the conductive textile or nonwoven can also be manufactured by applying the conductive lacquer to a pre-made textile or nonwoven that is formed from non-conductive threads or fibers for example. The non-conductive threads or fibers are made from natural fibers or a plastic for example.

The conductive textile is preferably formed by interweaving the conductive threads or fibers with each other or with non-conductive threads or fibers, as appropriate. The conductive nonwoven is preferably formed from a specified proportion of the conductive material, e.g. iron wool, which is processed into the conductive nonwoven with non-conductive fibers, as appropriate. The ohmic resistance of the conductive textile or nonwoven depends on the ohmic resistance of the conductive material and on the proportion of the conductive threads or fibers in the conductive textile or nonwoven.

Due to the mechanical properties of the conductive textile or nonwoven, the at least one antenna 7 can be very easily arranged and fixed in or against the seat cover 6, in or against one of the layers that may be provided between the seat cover 6 and the seat pad 4, or against the seat-heating or seat-occupancy mat that may be provided. It is very easily fixed, for example by stitching, weaving, bonding or laminating. However, the at least one antenna can also be arranged and fixed against the surface of the seat pad 4 or in the seat pad 4. In particular if the conductive textile is woven as a wide mesh, the at least one antenna 7 can be particularly easily and reliably arranged and fixed in or against the seat pad 4 by foaming it into said seat pad 4 when the latter is manufactured. The foam of the seat pad 4 can then penetrate the conductive textile, thus fixing it particularly reliably. Furthermore, the at least one antenna 7 is electrically insulated by the foam of the seat pad 4, apart from at least one electrical supply line to the antenna 7.

The at least one antenna 7 is preferably formed from strips of conductive textile or nonwoven (FIG. 2). Alternatively, an appropriate antenna structure can be cut or punched out of a large sheet of conductive textile or nonwoven. A first, second and third strip S1, S2, S3 made from conductive textile or nonwoven are arranged so that they are flat and at right angles, and connected to one another in an electrically conductive manner, thus forming a transmitting antenna 8 which surrounds a receiving antenna 9 on three sides in a frame-like manner. The receiving antenna 9 is formed from a first, second, third, fourth and fifth strip E1, E2, E3, E4, E5 of conductive textile or nonwoven. The first, second, third and fourth strips E1, E2, E3, E4 of the receiving antenna 9 are arranged parallel to each other and at a distance from each other. Furthermore, these four strips of the receiving antenna are arranged so that they are parallel to the first and third strips S1, S3 of the transmitting antenna 8. These four strips of the receiving antenna 9 are connected to each other in an electrically conductive manner by means of the fifth strip E5 of the receiving antenna 9 at their ends which face the second strip S2 of the transmitting antenna 8. The fifth strip E5 of the receiving antenna 9 is arranged so that it is parallel to the second strip S2 of the transmitting antenna 8. Furthermore, the transmitting antenna 8 and the receiving antenna 9 are arranged in such a way that they are electrically insulated from each other. The transmitting antenna 8 and the receiving antenna 9 can be coupled to a transmitting and receiving unit 10 by means of appropriate electrical supply lines. In particular, the first and third strips S1, S3 of the transmitting antenna 8 and the first, second, third and fourth strips E1, E2, E3, E4 of the receiving antenna 9 exhibit an electrical supply line of this type.

Depending on which of the strips of the receiving antenna 9 are used for the reception, the receiving area of the receiving antenna 9 can be selected according to the relevant requirements. In this way, the receiving area of the receiving antenna 9 is particularly large, for example, if the first and the fourth strips E1, E4 are used together with the fifth strip E5 of the receiving antenna 9. Accordingly, two receiving antennae that are arranged next to each other can be formed using, for example, the first and third strips E1, E3 of the receiving antenna 9 or the second and fourth strips E2, E4 of the receiving antenna 9 together with the fifth strip E5 of the receiving antenna 9. This produces two overlapping receiving antennae. By alternating the use of these two receiving antennae by means of an appropriate switching of the associated supply lines by the transmitting and receiving unit 10, it is possible to reliably detect the positioning of the child seat arranged on the vehicle seat by analyzing the signals received from each. The signal is generated by at least one resonator or transponder arranged in the child seat which is caused to oscillate by the electromagnetic waves emitted by the transmitting antenna 8. The resulting electromagnetic waves in turn cause an electric oscillating circuit that is formed by the receiving antenna 9 and the transmitting and receiving unit 10 to oscillate.

The at least one antenna 7 can also be configured differently. For example, the at least one antenna 7 is arranged as a capacitor plate in each instance for a capacitive seat-occupancy system. The relative permittivity of the capacitor arranged in this way is dependent on the occupancy of the vehicle seat, e.g. by a person, a child seat or a shopping bag placed on the vehicle seat.

The geometry of the at least one antenna 7 can be arranged as desired according to the relevant requirements. In particular, the at least one antenna 7 can also be very accurately configured for high-frequency application.

The at least one antenna 7 can also be alternatively or additionally provided in the backrest 2 for example.

1-6. (canceled)

7. A conductive textile, comprising:
elements selected from the group consisting of threads and fibers, said elements one of formed from a conductive material, coated with said conductive material, and interspersed with said conductive material, said elements being woven as a wide mesh resulting in the conductive textile such that a foam of a seat pad of a vehicle seat can penetrate the conductive textile during a manufacture of the seat pad.

8. An antenna to be coupled to one of a transmitting unit and a receiving unit, the antenna comprising:
a conductive textile having elements selected from the group consisting of threads and fibers, said elements one of formed from a conductive material, coated with said conductive material, and interspersed with said conductive material, said elements being woven as a wide mesh resulting in said conductive textile.

9. A vehicle seat, comprising:
a seat pad formed of foam;
a seat cover; and
at least one antenna being fixed by said antenna laying in said foam of said seat pad, said antenna being formed from one of a conductive textile and a nonwoven and being separate from said seat cover, said antenna provided for coupling to one of a transmitting unit and a receiving unit.

10. The vehicle seat according to claim 9, wherein said conductive textile is woven as a wide mesh.

11. The vehicle seat according to claim 9, wherein said at least one antenna is disposed and fixed in or against said seat cover.

12. The vehicle seat according to claim 11, wherein said at least one antenna is fixed by one of stitching, weaving, bonding and laminating.

13. The vehicle seat according to claim 9, further comprising a layer selected from the group consisting of a textile layer, a nonwoven layer and a foam layer, said layer disposed between said seat cover and said seat pad, said at least one antenna is disposed and fixed in or against said layer.

14. The vehicle seat according to claim 13 wherein said at least one antenna is fixed by one of stitching, weaving, bonding and laminating.

15. The vehicle seat according to claim 9, further comprising a mat selected from the group consisting of a seat-heating mat and a seat-occupancy mat, said at least one antenna is disposed and fixed against said mat.

16. The vehicle seat according to claim 15, wherein said at least one antenna is fixed by one of stitching, weaving, bonding and laminating.
